(19) United States
(12) Patent Application Publication
(10) Pub. No.: US 2018/0197087 A1
(43) Pub. Date: Jul. 12, 2018

(54) SYSTEMS AND METHODS FOR RETRAINING A CLASSIFICATION MODEL

(71) Applicant: Accenture Global Solutions Limited, Dublin (IE)

(72) Inventors: Song Luo, Gaithersburg, MD (US); Malek Ben Salem, Falls Church, VA (US)

(21) Appl. No.: 15/400,298

(22) Filed: Jan. 6, 2017

(51) Int. Cl. G06N 5/04; G06N 3/08

(52) U.S. Cl. CPC G06N 5/04; G06N 3/08

(57) ABSTRACT

A computer-implemented method that includes a computing system generating a first classification model for determining a classification of a data item. The first classification model is generated using at least baseline content data or baseline metadata. The system receives modified content data indicating a change to the baseline content data and modified metadata indicating a change to the baseline metadata. The system generates an impact metric based on at least the modified content data or the modified metadata and compares the impact metric to a threshold metric to determine whether the impact metric exceeds the threshold metric. In response to the impact metric exceeding the threshold impact metric, the system generates a second classification model for determining a classification of the data item.

### CROSS-REFERENCE TO RELATED APPLICATION

This application is related to U.S. patent application Ser. No. 15/400,112, entitled “Security Classification by Machine Learning,” filed on Jan. 6, 2017, and Attorney Docket Number 12587-0617001. The entire disclosure of U.S. patent application Ser. No. 15/400,112 is expressly incorporated by reference herein in its entirety.

### FIELD

The present specification is related to classification of electronic data items.

### BACKGROUND

Computer networks include multiple computing assets that enable individuals or users to access shared resources including a variety of digital content and electronic data items. Various entities such as private corporations, clandestine services and defense organizations can have large networked data sets that include a variety of electronic documentation. These electronic documents can include sensitive information. The sensitive data content or other attributes associated with the documents can require network users within the various entities to apply a particular security label or classification to the electronic document.

### SUMMARY

A computing system is described that generates a first classification model for determining a security classification of data items such as electronic files or documents including text and image content. The first classification model can be generated using at least baseline content data or baseline metadata that are extracted from the documents. The system receives modified and/or new content data that indicates changes to the baseline content data as well as modified and/or new metadata that indicates changes to the baseline metadata.

The system generates an impact metric based on at least the modified content data or the modified metadata. The impact metric can estimate an impact to the accuracy of the security classifications determined by the first model. The system compares the impact metric to a threshold impact metric to determine whether the impact metric exceeds the threshold metric. In response to the impact metric exceeding the threshold impact metric, the system generates a second classification model for determining a classification of the data item.

An innovative aspect of the subject matter described in this specification can be embodied in a computer-implemented method. The method includes, generating, by a computing system, a first classification model for determining a classification of a data item, the first classification model being generated using at least one of baseline content data or baseline metadata. The method further includes, receiving, by the computing system, modified content data indicating a change to the baseline content data used to generate the first classification model, the modified content data corresponding to content of the data item; and receiving, by the computing system, modified metadata indicating a change to the baseline metadata used to generate the first classification model, the modified metadata corresponding to an attribute of the data item. The method further includes, generating, by the computing system, an impact metric associated with an attribute of the first classification model, the impact metric being based on at least one of the modified content data or the modified metadata; comparing, by the computing system, the generated impact metric to a threshold impact metric; and determining, by the computing system, that the generated impact metric exceeds the threshold impact metric. The method further includes, generating, by the computing system, a second classification model for determining a classification of the data item, the second classification model being generated in response to the impact metric exceeding the threshold impact metric.

These and other implementations can each optionally include one or more of the following features. For example, in some implementations, the method further comprises: receiving, by the computing system, user data indicating an assessment of one or more data item classifications determined by the first classification model; and generating, by the computing system, the impact metric associated with the attribute of the first classification model, the impact metric being based on the received user data.

In some implementations, the method further comprises: receiving, by the computing system, modified context data associated with one or more modified contextual factors that indicate a change to baseline contextual factors used to generate the first classification model; and generating, by the computing system, the impact metric associated with the attribute of the first classification model, the impact metric being based on the modified context data. In some implementations, the impact metric indicates at least one of: an estimate of an impact scope; a probability of the first classification model determining an inaccurate classification; or a cost estimate associated with generating the second classification model.

In some implementations, the impact scope corresponds to at least one of: an estimate of the extent to which modified content data differs from the baseline content data that is used to generate the first classification model; an estimate of the extent to which modified metadata differs from the baseline metadata used to generate the first classification model; or an estimate of the extent to which modified context data differs from the baseline context data used to generate the first classification model.

In some implementations, the data item is an electronic document including text based content, and the method further comprises: scanning, by the computing system, the electronic document to identify text based content data associated with a particular document classification; and generating, by the computing system, one of the first classification model or the second classification model based on the identified text based content data.

In some implementations, the generated impact metric is associated with a parameter value, and determining that the generated impact metric exceeds the threshold impact metric comprises: determining, by the computing system, that the parameter value exceeds a threshold parameter value. In some implementations, the data item is an electronic document including a plurality of attributes, and the method further comprises: scanning, by the computing system, the electronic document for metadata corresponding to a particular attribute associated with a particular document classification; and generating, by the computing system, one of the first classification model or the second classification model based on the particular attribute.

In some implementations, generating the first classification model includes using machine learning logic to train the first classification model to determine the classification of the data item; and generating the second classification model includes using the machine learning logic to retrain the first classification model to determine the classification of the data item, the first classification model being retrained based on at least one of the modified content data or the modified metadata. In some implementations, generating the second classification model further comprises: retraining, by the computing system, the first classification model in response to the generated impact metric exceeding the threshold impact metric.

Other implementations of the above and other aspects include corresponding systems, apparatus, and computer programs, configured to perform the actions of the methods, encoded on computer storage devices. An electronic system of one or more computers can be so configured by virtue of software, firmware, hardware, or a combination of them installed on the electronic system that in operation cause the system to perform the actions. One or more computer programs can be so configured by virtue of having instructions that, when executed by data processing apparatus, cause the apparatus to perform the actions.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 illustrates a block diagram of an example computing system for generating an updated classification model.

FIGS. 2A and 2B illustrate block diagrams of example computing systems including multiple modules that interact to generate an updated classification model.

FIG. 3 illustrates a block diagram of an example computing system that includes model training used to generate an updated classification model.

FIG. 4 illustrates a flowchart of an example process for generating an updated classification model.

Like reference numbers and designations in the various drawings indicate like elements.

### DETAILED DESCRIPTION

The subject matter described in this specification relates to methods and systems that utilize machine learning logic to generate a first/initial current classification model for determining a security classification or label for electronic data items such as digital/electronic documents. The system can be implemented in an example computing network that includes a multitude of electronic documents and metadata attributes. The initial classification model can be generated using a baseline dataset of content data and metadata.

Over time, changes such as revisions, additions, deletions, or various other modifications to the baseline content used to generate the first classification model may necessitate that a new or updated classification model be generated to replace the first model. An impact metric can be analyzed and compared to a threshold impact metric to determine when to trigger an update or retraining of the first model. When the impact metric exceeds the threshold metric, the machine learning logic can be used to retrain the first classification model to generate a second classification model to replace the first model.

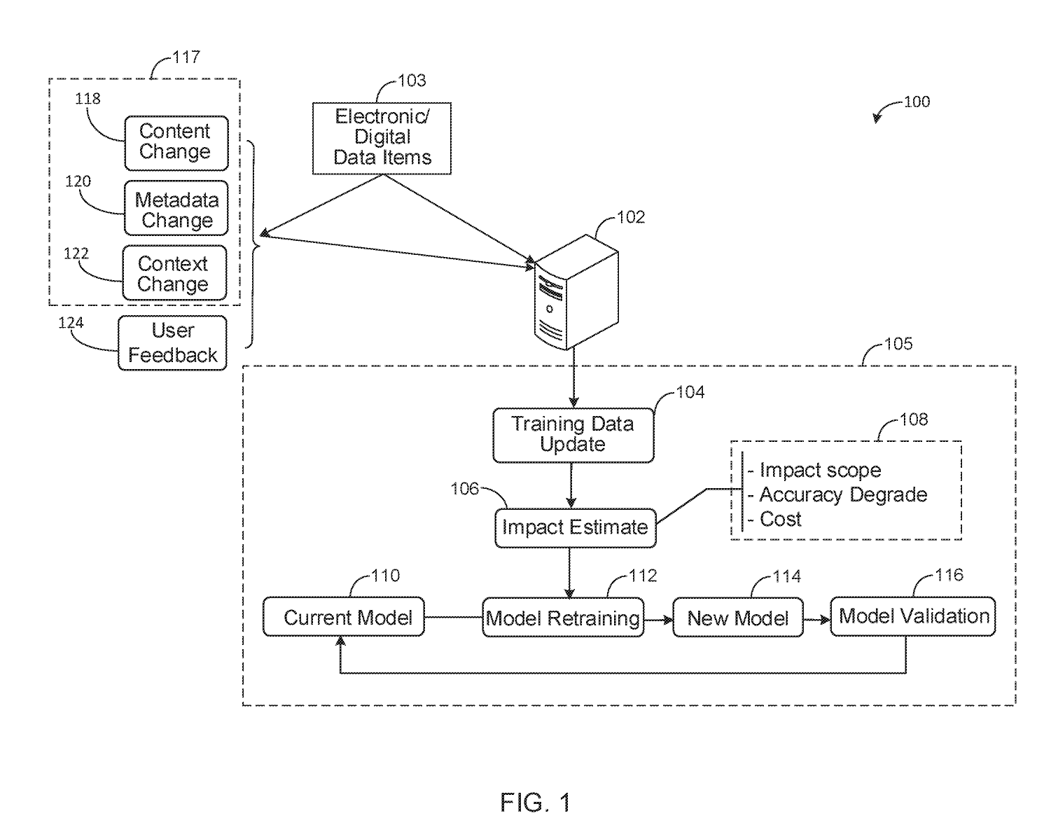

FIG. 1 illustrates a block diagram of an example computing system 100 for generating an updated classification model. System 100 includes a computing device 102 that can receive multiple electronic/digital data items 103 as well as data associated with the electronic items such as context data and metadata. Computing device 102 can include one or more different computing devices such as computing servers or a variety of different cloud-based computer systems. Further, computing device 102 can include multiple processing units, computer storage mediums, and/or computing modules configured to execute computer program code, machine readable instructions, or logic algorithms.

In some implementations, multiple documents 103 that have existing security classifications can be used by system 100 to initially train an example classification model that is deployed as a current model used to determine security classifications of documents. Hence, in response to the training, system 100 generates an initial current classification model for deployment in an example computer network.

Details and descriptions relating to computing systems and computer-implemented methods for generating initial/current classification models and validation of the models are described in related U.S. patent application Ser. No. 15/400,112, entitled “Security Classification by Machine Learning,” filed on Jan. 6, 2017, and Attorney Docket Number 12587-0617001. The entire disclosure of U.S. patent application Ser. No. 15/400,112 is expressly incorporated by reference herein in its entirety.

System 100 further includes a sub-system 105 that receives data from computing device 102. In some implementations, sub-system 105 can be a single module or a collection of modules and computational devices. The one or more modules and devices that form sub-system 105 interact to receive and process updated training data 104 and generate an impact estimate 106 based on the received training data 104.

Further, the one or more modules of sub-system 105 can execute model retraining 112 to retrain a current classification model 110 to generate an updated or new classification model 114 based on the impact estimate exceeding a threshold. New model 114 is eventually launched or deployed within an example computer network to become current model 110. Prior to the launch of new model 114 as the current model, model validation 116 is executed to validate accuracy of new model 114.

Updated training data 104 can include multiple data items 103 such as computer generated electronic/digital documents or files. Example electronic documents include Microsoft (MS) Word documents, MS PowerPoint documents, MS Excel documents, and/or PDF documents. Training data 104 can further include multiple data items corresponding to content change 118, metadata change 120, context change 122, and user feedback 124.

Content change 118, metadata change 120, and context change 122 collectively form modified data 117. Modified data 117 corresponds to changes made to baseline data used to generate an initial current classification model 110 deployed in an example computer network. For example, a first initial classification model can be generated based on an initial baseline aggregation of content data, metadata, and context factors. Modified data 117 is representative of changes to the baseline data which have the potential to impact, reduce, or degrade the accuracy of classifications generated by current model 110.

As used in this specification, modifications to baseline data items/documents that create or form modified data 117 can include, but are not limited to, document changes, document revisions, document additions, document deletions, or any other document alterations that causes a document to differ in any way from a baseline version of the document used to generate model 110. Further, modifications to baseline data items/documents also include changes, revisions, additions, deletions, or any other alterations that causes the document's content, metadata attributes, or context factors to differ in any way from a baseline version of the document.

Impact estimate 106 can be calculated or determined based on modified data 117 included within training data 104. Impact estimate 106 provides an estimated impact to the performance of the initial classification model based on the extent to which modified data 117 differs from the baseline aggregated data. An example primary impact to the performance of the initial model can be a reduction in the accuracy of security classifications/security labels generated for documents created and stored within the example computer network.

In some implementations, impact estimate 106 can generate an impact metric with a calculated metric value that quantifies a determined impact to current classification model 110. In some implementations, the impact metric indicates items of data structure 108 (i.e., impact scope, accuracy reduction, and cost). For example, the impact metric can indicate at least one of: an estimate of an impact scope; a probability of first/current model 110 determining an inaccurate security classification; or a cost estimate associated with retraining the first classification model to generate the second classification model.

In some implementations, and with reference to sub-system 105 of FIG. 1, the drawing features 104, 106, 108, 110, 112, 114, and 116 can each correspond to computational logic, program code, or computer program instructions that are executable by an example processor to cause system 100 to perform the described functions. In some implementations, these computational logic, program code, or computer program instructions are associated with one or more modules of device 102 and can be stored in an example non-transitory computer readable storage medium of device 102.

In some implementations, computing device 102 can include a single or multiple modules and system 100 can include one or more additional computing devices or related server devices. The modules of system 100 can be associated with computing device 102 and, for example, can be disposed within device 102. In alternative implementations, the modules of system 100 can include independent computing devices that are coupled to, and in data communication with, device 102. In some implementations, computing modules of device 102 are representative of machine learning, neural network inference computations, and/or data extraction and analysis functions that can be executed by device 102.

As used in this specification, the term “module” is intended to include, but is not limited to, one or more computers configured to execute one or more software programs that include program code that causes a processing device(s) or unit(s) of the computer to execute one or more functions. The term “computer” is intended to include any data processing device, such as a desktop computer, a laptop computer, a mainframe computer, a personal digital assistant, a server, a handheld device, or any other device able to process data.

Computing device 102 and any corresponding modules can each include processing units or devices that can include one or more processors (e.g., microprocessors or central processing units (CPUs)), graphics processing units (GPUs), application specific integrated circuits (ASICs), or a combination of different processors. In alternative embodiments, device 102 include other computing resources/devices (e.g., cloud-based servers) that provide additional processing options for performing one or more of the machine learning determinations and calculations described in this specification.

The processing units or devices can further include one or more memory units or memory banks. In some implementations, the processing units execute programmed instructions stored in memory to cause device 102 to perform one or more functions described in this specification. The memory units/banks can include one or more non-transitory machine-readable storage mediums. The non-transitory machine-readable storage medium can include solid-state memory, magnetic disk, and optical disk, a random access memory (RAM), a read-only memory (ROM), an erasable programmable read-only memory (e.g., EPROM, EEPROM, or Flash memory), or any other tangible medium capable of storing information.

As an example to illustrate the operation of system 100, program code including machine learning logic for current model 110 can be executing within device 102. In this example, device 102 is connected to an electronic document repository of an example computer network. The document repository can have several Word documents or PowerPoint files that relate to a variety of topics (intelligence, defense, mergers, divestitures, drone technology, etc.).

The several word documents and presentation files may not have existing security labels that indicate a classification of the documents/files. Hence, current model 110 executes within device 102 to classify the word documents and presentation files in the document repository. For example, a set of 10 documents classified by current model 110 can receive security labels such as “top secret,” “sensitive,” “export controlled,” or “secret.”

The word files and presentation files will include a variety of words or phrases, image/picture data, graphics data, or other related content that establish or indicate content data of the files. In some instances, documents may reside in electronic file folders with folder names that indicate the document is affiliated with the Finance, Accounting, or Military programs department. Information that a document is affiliated with (or owned by) a particular department or program/office can indicate an environment context of the document and the actual department or program can establish a context factor of the document.

Further, the Microsoft Word/PowerPoint files and other related documents can each include metadata that is detectable through a properties function of the file. Example metadata viewable when examining document properties can include document title, file name, authors, date created, date modified, content type, or folder path. These document property items can establish or identify metadata attributes of the document.

Current model 110 analyzes the document contents including words, phrases, and n-grams within the document to classify and generate accurate security labels for the documents. Model 110 can also analyze the metadata (e.g., author, date created) of the documents and the context factors (e.g., department affiliation) of the documents to classify and generate accurate security labels for the documents.

For example, model 110 can determine the classifications by referencing content data and metadata inference associations that are generated using machine learning logic. These inference associations can represent trained machine logic that over time associates certain words/phrases/n-grams (content data) to certain security labels. Likewise, the inference associations can also represent trained machine logic that over time associates certain titles/filenames/authors (metadata) to certain security labels.

When system 100 and current model 110 are launched within the example network, device 102 connects to the repository to scan each document/file and extract words or phrases from each word document or presentation file, extract metadata, extract context factors, and extract existing security labels.

In this example illustrating operation of system 100, the set of 10 classified documents discussed above may be modified over time. Device 102, connected to the repository, can periodically scan classified documents in the repository to detect modifications or changes to the documents. Modifications to the documents can include changes to content data (e.g., revisions adding new phrases), metadata (e.g., date modified or new authors), and context factors (e.g., new department affiliation/ownership).

These modifications can cause new associations to form, such as: between certain content data and certain security labels; between certain metadata and certain security labels, and between certain context factors and certain security labels. So, in view of these new associations, current model 110 may be generating security labels for new word documents and presentation files based on old or outdated inference associations. Hence, the accuracy of security labels generated by model 110 may degrade or reduce over time as the scope of modifications/changes to the document set increases.

Current model 110 may eventually require retraining to generate a new model 114 that uses more recent inference associations. Retraining can depend on the scope of the modifications/changes to the documents and how those changes effect the legitimacy of the initial inference associations were used to train model 110. Device 102 can estimate the impact of the modifications using an impact metric that estimates the scope of the modifications, the amount of accuracy reduction, and the cost to retrain the current model. The impact estimate can also estimate a business cost/impact such as profit loss when current model 110 inaccurately classifies certain documents. The impact estimate is compared to a threshold and current model 110 is retrained to generate new model 114 when the estimated impact metric exceeds the threshold.

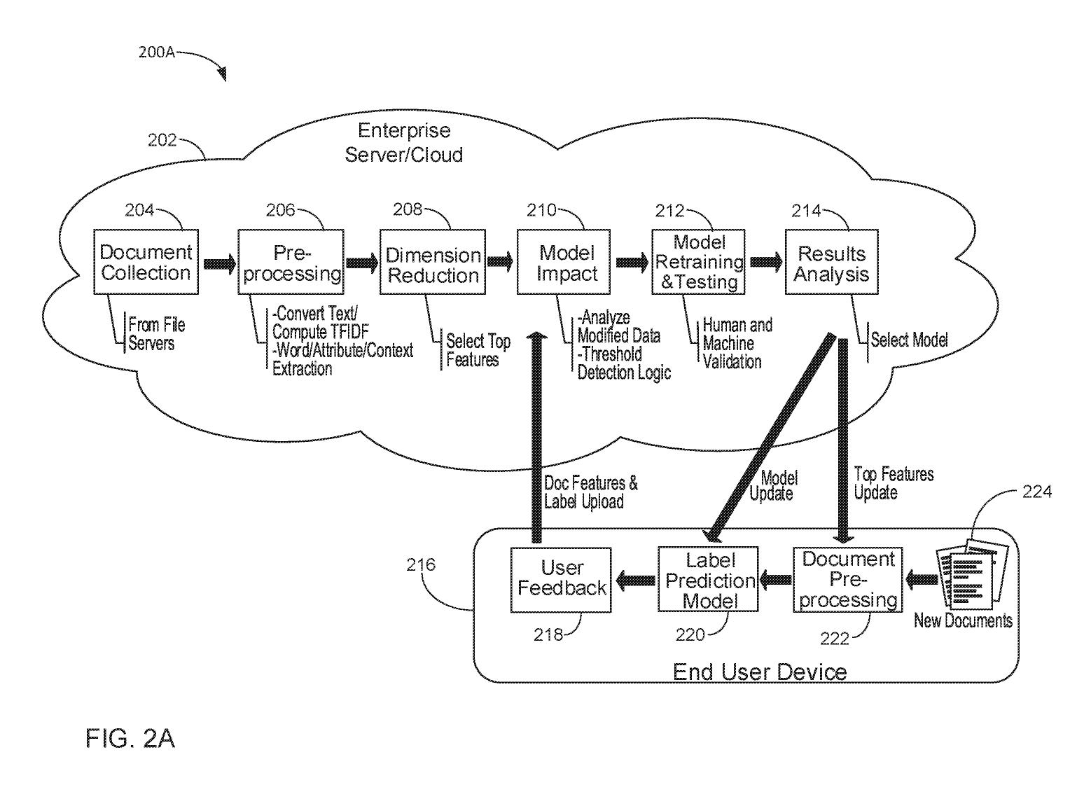

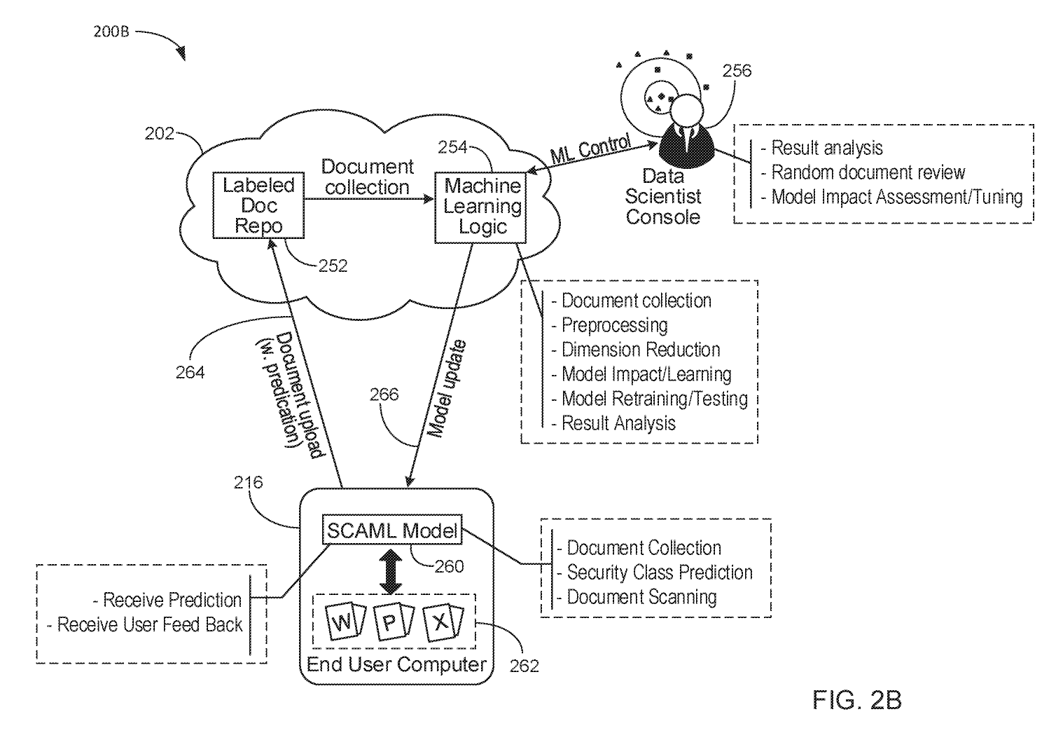

FIG. 2A illustrates a block diagram of a computing system 200A that includes multiple computational logic blocks (or modules) that interact to generate an updated/new classification, such as new model 114. System 200A includes enterprise server/cloud 202. In some implementations, system 200A is sub-system of computing device 102. For example, one or more modules of computing device 102 can cooperate and interact to form enterprise server/cloud 202.

In some implementations, server/cloud 202 of system 200A can be disposed locally within an example computer network of a client, a customer, a private entity, or public, defense, or intelligence entity. In alternative implementations, server/cloud 202 of system 200A can be disposed remotely in an external cloud computing environment and exchanges data communications with the example computer network via the internet.

In the implementation of FIG. 2A, the drawing features 204, 206, 208, 210, 212, and 214 can each correspond to computational logic, program code, or computer program instructions that are executable by an example processor to cause system 200A to perform the described functions. In some implementations, these computational logic features, program code features, or programmed instructions are associated with one or more modules of server/cloud 202 and can be stored in an example non-transitory computer readable storage medium of server/cloud 202.

Server 202 includes multiple logic features that can be used to iteratively generate updated security classification models. The classification models can be used by one or more users to classify and/or generate security labels for electronic data items created and stored within an example computer network. As used in this specification, while security classification and security label are synonymous, in some stances references to security classification can include an example classification operation performed by system 200A to generate a security label for a document. Example security labels can include Secret, Top Secret, Sensitive, Classified, Export Controlled, For Official Use Only or any other related security label.

As shown in FIG. 2A, server 202 includes document collection 204, pre-processing 206, dimension reduction 208, model impact 210, model testing 212, and results/analysis 214. As indicated above, each block or reference feature of server/cloud 202 corresponds to computational or programmed logic features that can be executed by a processor of server 202 to perform a corresponding described function.

System 200A further includes end user device 216. User device 216 can be an example end user device such as a desktop/laptop computer, a thin client device, a mobile computing device, a tablet or smartphone device, or any other related computing device. Device 216 includes user feedback 218, classification prediction model 220, and document pre-processing 222.

Similar to server 202, each block or reference feature of user device 216 corresponds to computational or programmed logic features that are executable by an example processor of user device 216 to perform a corresponding function. As described in more detail below, new documents 224 are provided to device 216 to receive a security classification or label.

The implementation of FIG. 2A can illustrate example operational states of system 200A. For example, system 200A includes one or more processes or features that operate or run in both a server/cloud environment as well as on an end user's computing device 216. The features or data blocks of server 202 cooperate and interact to produce/generate an example robust classification model that accurately predicts security classification labels for new documents 224.

Once generated, the classification model can be provided to user device 216 and stored in a storage-medium of device 216 for local operation on the device (i.e., as prediction model 220). Thus, when a user creates new documents 224, security label prediction model 220 will be available locally for the user to execute/launch and classify/generate security labels for new documents 224.

Regarding an example operation of server 202, document collection 204 includes server 202 receiving or collecting multiple documents 103 from an example document file server of the example computer network (e.g., an electronic document repository). At pre-processing 206, the multiple collected documents are scanned and processed such that relevant data can be detected/identified, and/or extracted.

In some implementations, example text conversion algorithms can be executed to extract one or more content data, metadata attributes or context factors. For example, a term frequency-inverse document frequency (TFIDF) algorithm can be executed by server 202 to determine how important a particular word is to documents in a collection or text corpus or respective documents. In some implementations, the TFIDF algorithm is used to detect or determine important words associated with a document's text content, a document's metadata attributes, and a document's contextual factors.

In an example operation executed by server 202, the TFIDF algorithm can be used to describe or determine how significant a particular word is for a generated security label. In some instances, server 202 can scan a first document and detect or identify a particular word that appears relatively often within the first document. The particular word, and the associated frequency with which the word appears in the first document, may be important for determining the security classification of the first document. However, in another instance, if that particular word appears less often in other documents, then that particular word may become less important relative to generating a global classification inference associated with that particular word.

Thus, multiple distinct word occurrences across multiple documents may be combined to generate an accurate classification model and/or to iteratively update a generated first classification model to produce subsequent classification models. For example, execution of the TFIDF algorithm can cause server 202 to: consider how often a particular word appears in a single document; consider how often a particular word appears in other documents relative to the single document; and generate an overall estimate of how important a particular word is based on the words relative occurrence within one or more relevant documents.

In some implementations, TFIDF can ultimately be a number which provides an estimate of how important a particular word or particular word sequence is for accurately determining a document's security classification. Example algorithms using TFIDF can include a Support Vector Machine (SVM) algorithm and a Center Based Similarity (CBS) algorithm. SVM algorithms can be generally described as a popular machine learning algorithm used as a benchmark in the data mining field.

In some implementations, the SVM algorithm can be configured to manage real world data such as data sets that are unbalanced. CBS algorithms provide a new/novel innovation in the field of document security classification, the present specification can implement unique software packages for use with the CBS algorithms to generate accurate security labels for classification of unbalanced data.

Referring again to the example operation executed by server 202, dimension reduction 208 includes selecting the top features from among the multiple relevant extracted text/words, metadata attributes or context factors identified during pre-processing 206. For example, server 202 can execute embedded machine learning logic to iteratively identify and select top features or attributes that are identified as important to determining a particular security classification.

In some implementations, server 202 generates a first set of top features that are used to generate an initial/first current classification model, such as current model 110 described above. For example, the first initial classification model can be generated based on an initial baseline aggregation of content data, metadata, and context factors. In some instances, the first set of top features can correspond to aggregated baseline content data, baseline metadata, and baseline context factors.

In some implementations, certain document attributes are identified or selected as top features based on how often a particular attribute is associated with a particular security classification. For example, selected top features can be based on respective feature sets that include top text/word features (i.e., content data) that contribute to certain security classifications, top metadata features that contribute to certain security classifications, and top contextual factors/features that contribute to certain security classifications.

For example, content data top features can include word sequences that include a single word or consecutive words that appear as text in a particular document. Embedded machine learning logic, through iterative scans of multiple documents 103, can identify that the word “Whitehouse” is a top content data feature that contributes to a top secret security label of multiple documents. Likewise, the word sequence of “Congress Rumors” can also be identified as a second top content data feature that contributes to a top secret security label of multiple documents.

Model impact 210 includes one or more logic constructs and algorithms used to generate an impact estimate based at least on analysis of modified data. The modified data can indicate one or more changes to baseline data used to generate the initial or current classification model. In some implementations, the impact estimate is based on an impact scope that indicates, for example, the extent to which a second set of top features generated by server 202 differs from the first set of top features generated by server 202.

In some implementations, the impact scope can correspond to at least one of: 1) an estimate of the extent to which the top features among modified content data (e.g., document text/words) differs from the top features among the baseline content data used to generate the first classification model; 2) an estimate of the extent to which the top features among modified metadata attributes (e.g., document title/owner) differs from the top features among baseline metadata attributes used to generate the first classification model; or 3) an estimate of the extent to which the top features among modified context data (e.g., business/department affiliation) differs from the top features among baseline context data used to generate the first classification model.

By way of example, server 202 includes functions and features, that enable a current classification model (e.g., current model 110) to be continually improved based on new information that is received by server 202. In some implementations, the new information sources are provided to server 202, in part, by user device 216 and based on the initial deployment of the current model. While in other implementations, new information sources can be received based on updates or content data changes, metadata changes, or context data changes associated with multiple documents of document collection 204.

In some implementations, server 202 processes and analyzes updates made to the multiple documents to generate an impact metric that corresponds to the impact estimate. Server 202 can then execute threshold detection logic to compare the generated impact metric to a threshold impact metric. Based on the comparison, server 202 can determine whether to update the current classification model (i.e., generate a new classification model) or continue executing the current model. Thus, when the calculated impact metric exceeds the threshold impact metric, server 202 can initiate model retraining & testing 212 and then proceed to results analysis 214.

In some implementations, the impact estimate can control or provide an indication as to when server 202 will trigger retraining of an example current classification model. Hence, the impact estimate provides a control mechanism that server 202 can use to efficiently determine an appropriate time to trigger retraining and generate a new/updated classification model.

The calculated impact estimate (or metric) enables server 202 to determine the impact that document changes or modified data will have on the integrity of the current model and/or the overall classification accuracy of system 200A.

For example, the computed inferences enable server 202 to dynamically learn and detect factors that substantially contribute to: 1) increased impact scope to the current model; 2) reductions in classification accuracy of the current model; 3) increased costs of inaccurate classifications generated by the current model; and 4) costs of retraining the current classification model to generate a new classification model.

Based on the multiple computed inferences, model impact 210 can generate an impact estimate used to measure or quantify, for example, the balance between the cost of acceptance of inaccurate classifications generated by the current model and the cost of retraining the current model. Hence, the generated impact metric can be used in a threshold comparison that considers costs of retraining the current model relative to costs of acceptance of inaccurate classifications of the current model. If the cost of retraining exceeds or outweighs the cost of accepting inaccurate classifications, then server 202 will not initiate model training 212.

For example, for some large data centers with multiple data repositories, financial costs associated with retraining a current model can be substantial and can also require large amounts of computational resources. In some instances, entities with large data centers may include file servers and cloud-based systems that are distributed across disparate geographic locations and that do not store particularly sensitive information.

For these entities, initiating retraining of a current model can require identification of data from disparate locations. Because retraining costs are high and the stored data is not particularly sensitive, the cost of inaccurate classification will be relatively low. Thus, for these entities, system 200A can be configured to include a retraining trigger that has a relatively high impact threshold. For example, to trigger retraining of the current model, the impact scope and probability of inaccurate classification must be substantially high so as to exceed the high impact threshold.

As indicated above, delays in executing model retraining 212 can adversely impact or reduce the accuracy of predicted security labels generated by the current model. In some implementations, as the impact metric value increases, there can be a corresponding (e.g., a proportional) reduction in security classification accuracy. For example, a particular impact metric value (e.g., overall impact 5 on a 10-point scale) can result in a current model that has a 95% security classification accuracy. Alternatively, an impact metric value of 7/10 can result in a current classification model that has an 85% classification accuracy.

In some instances, a 10% reduction in classification accuracy is tolerable for an entity in which security label accuracy is less of a priority. While, in other instances, for entities that routinely handle sensitive information, a 10% reduction in classification accuracy can negatively impact a business's profitability. In some implementations, server 202 can execute program code to compute a cost or quantitative amount that estimates business impact based on a particular reduction in classification accuracy. For example, the computation can indicate that each 2% drop in classification accuracy corresponds to a potential $10,000 impact/reduction in business profitability.

In some implementations, the impact estimate can use the quantitative profit loss indicator as a basis to determine an appropriate impact threshold for determining when to trigger retraining of the current classification model. For example, server 202 can execute logic associated with model impact 212 to compute the profit loss amount and to compute an estimated cost of retraining the current model.

In some implementations, impact threshold can correspond to a particular retraining cost amount (e.g., $100,000), while the impact metric can correspond to the profit loss indicator. Thus, when the estimated profit loss (e.g., $110,000) exceeds the cost of retraining (e.g., $100,000), server 202 can trigger model training & testing 212 as well as results analysis 214 to generate an updated classification model, such as new model 114 described above.

As noted above, model retraining & testing 212 as well as results analysis 214 are substantially related to the multiple processes associated with training an initial classification model and data validation of the generated initial model. Accordingly, details and descriptions relating to computing systems and computer-implemented methods for training/retraining current classification models and validation of the models are described in related U.S. patent application Ser. No. 15/400,112, entitled “Security Classification by Machine Learning,” filed on Jan. 6, 2017, and attorney docket number 12587-0617001.

As shown, in the implementation of FIG. 2A, user device 216 includes a label prediction model 220 that is executed locally by the device. Server 202 can execute results analysis 214 and concludes the results analysis by generating and selecting a new/updated model to be provided to user device 216 as a model update for prediction model 220. Hence, classification prediction model 220 is iteratively updated based on when server 202 triggers retraining of an example current model to generate a model update for prediction model 220. Document pre-processing 222 corresponds substantially to the described functions of pre-processing 206.

As noted above, processes executed by server 202 enables a current classification model to be continually improved based on new information received by the server. In some implementations, the new information sources are provided to server 202 by user device 216. An example source of new information can be user feedback 218 provided to server 202 from users of device 216.

For example, a user can execute a classification process locally within device 216 to generate a security label for one or more new documents 224. In some implementations, program code associated with prediction model 220 can include graphical user interface that receives feedback from the user. The received feedback can indicate whether a particular security label generated by model 220 for new documents 224 is believed, by the user, to be either correct or incorrect.

In some implementations, server 202 can presume that the user's feedback about the accuracy of the generated security labels is correct. Hence, when presumed correct, user feedback 218 as an example data point for determining when to trigger retraining of the current model and can improve overall accuracy of the prediction model 220. In some implementations, server 202 receives user feedback 218 (e.g., user data) that indicates an assessment of one or more data item/document classifications determined by a first classification model iteration of prediction model 220.

Server 202 can then generate an impact metric that is associated with an attribute of the first iteration of prediction model 220. The impact metric can be based on the received user feedback 218 and the attribute can relate to the accuracy of the security labels generated by prediction model 220 for new documents 224.

In some implementations, when user feedback 218 is not presumed correct, human data mining/classification experts (e.g., data scientists) can analyze aggregated datasets of user feedback 218. The human experts can also analyze security classifications generated by prediction model 220. The human experts can indicate the percentage of machine-learning based security labels generated by model 220 that are correct relative to the percentage that the received user feedback indicates is correct. In some instances, and based on the analysis, human experts can modify parameters of the machine-learning logic to improve the accuracy of prediction model 220.

FIG. 2B illustrates a block diagram of a computing system 200B that includes multiple modules that interact to generate an updated classification model. In some implementations, system 200B is a sub-system of server 202 and can include one or more of the functions and features described above with reference to the implementation of FIG. 2A.

System 200B includes a document repository 252 having multiple documents that include existing security labels. Machine-learning logic 254 can receive modified data that includes text data, metadata attributes, and context factors associated with each document. In some implementations, machine-learning logic 254 can be executing within a local server or an external/non-local cloud-computing environment. Further, logic 254 can be configured to execute the one or more described functions associated with the multiple features of server 202.

For example, logic 254 can receive at least modified content data, metadata, and context data that includes changes to baseline content data, metadata, and context data used to generate a first iteration of model 260. Logic 254 can execute machine-learning computational processes to process received data, select top features, generate an impact metric, and initiate retraining of model 260 when the impact metric exceeds a threshold.

Model 260 can correspond to prediction model 220 and includes functionality relating to security classification by machine-learning (SCAML). Application files associated with model 260 can be stored locally within a storage-medium of device 216 and, thus, executed from end user device 216. Model updates 266 can be received from a non-local (relative to user device 216) machine-learning component that executes logic 254. In some implementations, model updates 266 are implemented by way of a conventional updating/patching protocol.

In an example operation, when a user creates a new document using device 216, model 260 is used to predict a document security label (e.g., secret, top secret, sensitive, classified, export controlled). User device 216 can cause the recommended security label to be displayed in an example application program such as MS Outlook or a related MS Office application program. Model 260 can be configured to collect user feedbacks that pertain to the accuracy of the prediction results. Classified documents and received user feedback are provided to server 202 via data communication path 264 and can be used by logic 254 to further train/retrain model 260.

In some implementations, model 260 provides a security label management solution for implementation as a plug-in application file that can launched from example MS Office applications 262 such as MS Word, MS PowerPoint, or MS Excel. For example, execution of the plug-in within new documents or email correspondences that incorporate model 260 can generate a security field that prompts the user to initiate a scan of the completed document. In response to completing the scan, model 260 can generate a security label and upload the labeled document to repository 252 for feature extraction and analysis by machine-learning logic 254.

Data scientist console 256 can include one or more computing assets that enable at least one data scientist/validator to conduct analysis of classified documents. The analysis can include the data scientist interacting with machine-learning logic 254 to validate or correct security label results/predictions generated by model 260. The data scientist can also conduct random reviews of classified documents, conduct model impact assessments and analysis, and tune or modify parameters associated with logic 254, such as, parameters used to generate impact estimates.

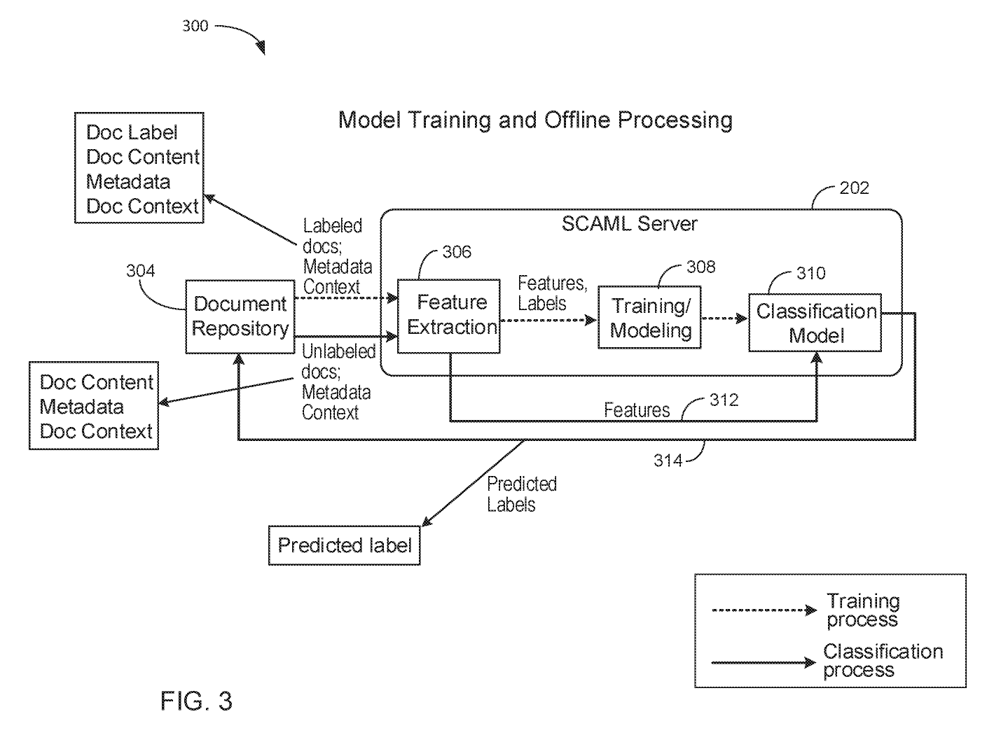

FIG. 3 illustrates a block diagram of an example computing system 300 that includes model training logic used to generate an updated classification model. In some implementations, system 300 is a sub-system of server 202 and can include one or more of the functions and features described above with reference to the implementation of FIGS. 2A and 2B.

System 300 includes a document repository 304 that stores multiple documents that include existing security labels as well as multiple unlabeled documents that require security labels. In some implementations, system 300 can operate in an offline mode or batch processing mode with minimal user input. While in these modes system 300 can scan and analyze large quantities of content data, metadata attributes, and context factors associated with documents stored in repository 304.

Scanned and analyzed data for labeled documents in repository 304 can be used by training/modeling logic 308 to train system 300 so as to generate a first iteration of classification model 310. In some implementations, system 300 generates the first iteration of model 310 by, in part, using machine-learning logic associated with training/modeling 308 to train the first model iteration to determine security classifications of unlabeled documents within repository 304.

Labeled documents within repository 304 are scanned and relevant features are extracted by feature extraction logic 306. In some implementations, the extracted features correspond to modified data 117 described above in the implementation of FIG. 1. While in other implementations, the extracted features correspond to baseline or modified top features described above in the implementation of FIG. 2A. Training/modeling 308 processes the one or more extracted features that are provided by feature extraction logic 306 and can tune the first model iteration using, for example, the baseline extracted top features.

In some implementations, while the first iteration of classification model 310 is executing to classify unlabeled documents, server 202 can execute program code to periodically scan, analyze, and extract data or features associated with labeled documents. The extracted data or features can correspond to document changes or modifications that have occurred over time. In some implementations, document changes or modifications to labeled documents can form a training dataset that is referenced by logic 308 when generating one or more iterations of classification model 310.

Training/modeling logic 308 can include at least one algorithm that generates an impact estimate based on the extent to which modified data/top features differs from baseline data/top features. Logic 308 can generate a second iteration of classification model 310 in response to the impact estimate exceeding a threshold. In some implementations, generating the second iteration of model 310 includes using machine learning logic to retrain the first model 310 to determine security classifications when modified data differs substantially from baseline data. Thus, the first classification model is retrained based on the difference between at least one of: baseline content data and modified content data; baseline metadata and modified metadata, or baseline context data and modified context data.

In example operations, the first iteration of model 310 can be used in the offline batch processing mode to generate security labels/classifications for multiple unlabeled documents. While in the offline batch processing mode, server 202 executes feature extraction logic 306 to scan, analyze, and extract one or more features from the unlabeled documents. The extracted features are provided as inputs to the first iteration of model 310 along data path 312. In some implementations, server 202 executes machine-learning logic to generate security labels for the unlabeled documents. The classified documents including the predicted labels are provided back to document repository 304 along data path 314.

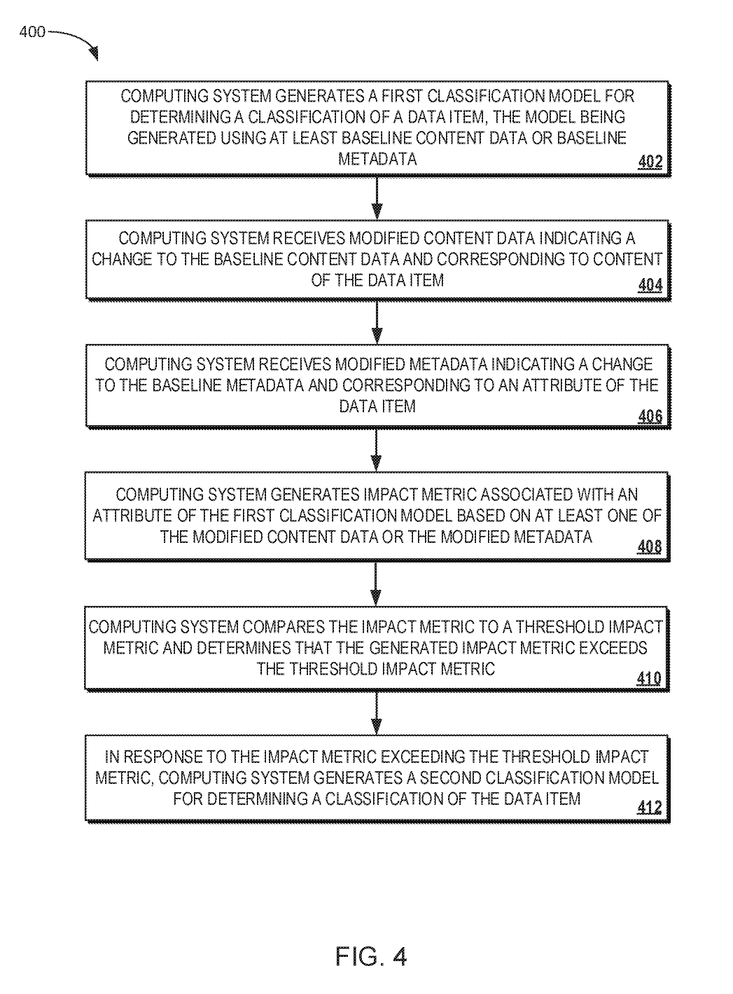

FIG. 4 illustrates a flowchart of an example process 400 for generating an updated classification model. Process 400 begins at block 402 and includes computing system 100 generating a first classification model for determining a classification of a data item. In some implementations, the data item is an electronic document or file and the first classification model is generated using at least one of baseline content data or baseline metadata. The baseline content data can correspond to text or words scanned and extracted from multiple electronic/digital electronic documents 103; and the baseline metadata can correspond to attributes (e.g., document author, department originating document) extracted from the document.

At block 404, process 400 includes computing system 100, receiving modified content data indicating a change to the baseline content data used to generate the first classification model. The modified content data can correspond to changes in text content of the data item such as changes words, phrases, or n-grams. The modified content data can indicate text or content changes to a document grouping used to create the first classification model. In some implementations, text and content changes have the potential to adversely impact or reduce the accuracy of security classifications generated by the first classification model.

At block 406, process 400 includes system 100 receiving modified metadata indicating a change to the baseline metadata used to generate the first classification model. The modified metadata can correspond to changes to one or more attributes of the data item such as changes in document ownership or department affiliation. The modified metadata can indicate attribute changes to a document grouping used to create the first classification model. In some implementations, metadata or attribute changes have the potential to adversely impact or reduce the accuracy of security classifications generated by the first classification model.

At block 408, process 400 includes system 100 generating an impact metric associated with an attribute of the first classification model. The impact metric can be generated based on at least one of the modified content data or the modified metadata. In some implementations, the attribute of the first classification model includes an impact scope that adversely affects the first classification model, an estimated accuracy reduction in the first model, and an estimated cost to mitigate impact to the first model.

In some implementations, the extent of change between baseline content data and modified content data can be linked in a linear relationship to an overall impact metric value. For example, the greater the extent of change or modification between the baseline content and the modified content the greater the effect on the overall impact metric value. Likewise, the extent of change between baseline metadata and modified metadata can be also linked in a linear relationship to the overall impact metric value. For example, the greater the extent of change or modification between the baseline metadata and the modified metadata the greater the effect on the overall impact metric value.

At block 410, computing system 100 compares the generated impact metric to a threshold impact metric and determines whether the generated impact metric exceeds the threshold impact metric. The threshold impact metric corresponds to a system threshold that, when exceeded, triggers retraining of the first classification model. In some implementations, the threshold impact metric is dynamically adjustable and can vary based on user preference.

At block 412 of process 400, computing system 100 generates a second classification model for determining a classification of the data item. The second classification model is generated in response to the generated impact metric exceeding the threshold impact metric. In some implementations, generating the second classification model corresponds to retraining the first classification model to produce an updated classification model (i.e., the second classification model).

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus.

Alternatively, or in addition, the program instructions can be encoded on an artificially generated propagated signal, e.g., a machine-generated electrical, optical, or electromagnetic signal, which is generated to encode information for transmission to suitable receiver apparatus for execution by a data processing apparatus. The computer storage medium can be a machine-readable storage device, a machine-readable storage substrate, a random or serial access memory device, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system.

A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array), an ASIC (application specific integrated circuit), or a GPU (General purpose graphics processing unit).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
generating, by a computing system, a first classification model for determining a classification of a data item, the first classification model being generated using at least one of baseline content data or baseline metadata;
receiving, by the computing system, modified content data indicating a change to the baseline content data used to generate the first classification model, the modified content data corresponding to content of the data item;
receiving, by the computing system, modified metadata indicating a change to the baseline metadata used to generate the first classification model, the modified metadata corresponding to an attribute of the data item;
generating, by the computing system, an impact metric associated with an attribute of the first classification model, the impact metric being based on at least one of the modified content data or the modified metadata;
comparing, by the computing system, the generated impact metric to a threshold impact metric;
determining, by the computing system, that the generated impact metric exceeds the threshold impact metric; and
generating, by the computing system, a second classification model for determining a classification of the data item, the second classification model being generated in response to the impact metric exceeding the threshold impact metric.

2. The method of claim 1, further comprising:
receiving, by the computing system, user data indicating an assessment of one or more data item classifications determined by the first classification model; and
generating, by the computing system, the impact metric associated with the attribute of the first classification model, the impact metric being based on the received user data.

3. The method of claim 1, further comprising:
receiving, by the computing system, modified context data associated with one or more modified contextual factors that indicate a change to baseline contextual factors used to generate the first classification model; and
generating, by the computing system, the impact metric associated with the attribute of the first classification model, the impact metric being based on the modified context data.

4. The method of claim 3, wherein the impact metric indicates at least one of:
an estimate of an impact scope;
a probability of the first classification model determining an inaccurate classification; or
a cost estimate associated with generating the second classification model.

5. The method of claim 4, wherein the impact scope corresponds to at least one of:
an estimate of the extent to which modified content data differs from the baseline content data that is used to generate the first classification model;
an estimate of the extent to which modified metadata differs from the baseline metadata used to generate the first classification model; or
an estimate of the extent to which modified context data differs from the baseline context data used to generate the first classification model.

6. The method of claim 1, wherein the data item is an electronic document including text based content, and the method further comprises:
scanning, by the computing system, the electronic document to identify text based content data associated with a particular document classification; and
generating, by the computing system, one of the first classification model or the second classification model based on the identified text based content data.

7. The method of claim 1, wherein the generated impact metric is associated with a parameter value, and wherein determining that the generated impact metric exceeds the threshold impact metric comprises:
determining, by the computing system, that the parameter value exceeds a threshold parameter value.

8. The method of claim 1, wherein the data item is an electronic document including a plurality of attributes, and the method further comprises:
scanning, by the computing system, the electronic document for metadata corresponding to a particular attribute associated with a particular document classification; and
generating, by the computing system, one of the first classification model or the second classification model based on the particular attribute.

9. The method of claim 1, wherein generating the first classification model includes using machine learning logic to train the first classification model to determine the classification of the data item; and
wherein generating the second classification model includes using the machine learning logic to retrain the first classification model to determine the classification of the data item, the first classification model being retrained based on at least one of the modified content data or the modified metadata.

10. The method of claim 9, wherein generating the second classification model further comprises:
retraining, by the computing system, the first classification model in response to the generated impact metric exceeding the threshold impact metric.

11. An electronic system comprising:
one or more processing devices;
one or more machine-readable storage devices for storing instructions that are executable by the one or more processing devices to perform operations comprising:
generating, by a computing system, a first classification model for determining a classification of a data item, the first classification model being generated using at least one of baseline content data or baseline metadata;
receiving, by the computing system, modified content data indicating a change to the baseline content data used to generate the first classification model, the modified content data corresponding to content of the data item;
receiving, by the computing system, modified metadata indicating a change to the baseline metadata used to generate the first classification model, the modified metadata corresponding to an attribute of the data item;
generating, by the computing system, an impact metric associated with an attribute of the first classification model, the impact metric being based on at least one of the modified content data or the modified metadata;
comparing, by the computing system, the generated impact metric to a threshold impact metric;
determining, by the computing system, that the generated impact metric exceeds the threshold impact metric; and
generating, by the computing system, a second classification model for determining a classification of the data item, the second classification model being generated in response to the impact metric exceeding the threshold impact metric.

12. The electronic system of claim 11, wherein the performed operations further comprise:
receiving, by the computing system, user data indicating an assessment of one or more data item classifications determined by the first classification model; and
generating, by the computing system, the impact metric associated with the attribute of the first classification model, the impact metric being based on the received user data.

13. The electronic system of claim 11, wherein the performed operations further comprise:
receiving, by the computing system, modified context data associated with one or more modified contextual factors that indicate a change to baseline contextual factors used to generate the first classification model; and
generating, by the computing system, the impact metric associated with the attribute of the first classification model, the impact metric being based on the modified context data.

14. The electronic system of claim 13, wherein the impact metric indicates at least one of:
an estimate of an impact scope;
a probability of the first classification model determining an inaccurate classification; or
a cost estimate associated with generating the second classification model.

15. The electronic system of claim 14, wherein the impact scope corresponds to at least one of:
an estimate of the extent to which modified content data differs from the baseline content data that is used to generate the first classification model;
an estimate of the extent to which modified metadata differs from the baseline metadata used to generate the first classification model; or
an estimate of the extent to which modified context data differs from the baseline context data used to generate the first classification model.

16. The electronic system of claim 11, wherein the data item is an electronic document including text based content, and the performed operations further comprise:
scanning, by the computing system, the electronic document to identify text based content data associated with a particular document classification; and
generating, by the computing system, one of the first classification model or the second classification model based on the identified text based content data.

17. The electronic system of claim 11, wherein the generated impact metric is associated with a parameter value, and wherein determining that the generated impact metric exceeds the threshold impact metric comprises:
determining, by the computing system, that the parameter value exceeds a threshold parameter value.

18. The electronic system of claim 11, wherein the data item is an electronic document including a plurality of attributes, and the performed operations further comprise:
scanning, by the computing system, the electronic document for metadata corresponding to a particular attribute associated with a particular document classification; and
generating, by the computing system, one of the first classification model or the second classification model based on the particular attribute.

19. The electronic system of claim 11, wherein generating the first classification model includes using machine learning logic to train the first classification model to determine the classification of the data item; and
wherein generating the second classification model includes using the machine learning logic to retrain the first classification model to determine the classification of the data item, the first classification model being retrained based on at least one of the modified content data or the modified metadata.

20. One or more machine-readable storage devices for storing instructions that are executable by the one or more processing devices to perform operations comprising:
generating, by a computing system, a first classification model for determining a classification of a data item, the first classification model being generated using at least one of baseline content data or baseline metadata;
receiving, by the computing system, modified content data indicating a change to the baseline content data used to generate the first classification model, the modified content data corresponding to content of the data item;
receiving, by the computing system, modified metadata indicating a change to the baseline metadata used to generate the first classification model, the modified metadata corresponding to an attribute of the data item;
generating, by the computing system, an impact metric associated with an attribute of the first classification model, the impact metric being based on at least one of the modified content data or the modified metadata;
comparing, by the computing system, the generated impact metric to a threshold impact metric;
determining, by the computing system, that the generated impact metric exceeds the threshold impact metric; and
generating, by the computing system, a second classification model for determining a classification of the data item, the second classification model being generated in response to the impact metric exceeding the threshold impact metric.
